(19) United States
(12) Patent Application Publication
(10) Pub. No.: US 2006/0167818 A1
(43) Pub. Date: Jul. 27, 2006

(54) Methods and system for performing data exchanges related to financial transactions over a public network

(76) Inventors: David Wentker, San Francisco, CA (US); Mike Lindelsee, Menlo Park, CA (US); Gabriel Wachob, Redwood City, CA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/040,363

(22) Filed: Jan. 21, 2005

(51) Int. Cl. H04L 9/00

(52) U.S. Cl. 705/64

(57) ABSTRACT

Methods and systems for exchanging data related to financial transactions utilizing a public network are disclosed. One or more participant computer systems are in communication with the public network. Each participant computer system includes at least one application for performing functions related to a financial transaction, and a gateway providing an interface for sending and receiving data between participant computer systems. At least one directory is used to identify a path for transmitting data between participant computer systems. Upon receiving a message from an application, the gateway accesses the directory to determine a destination address. The gateway then uses the address to open a channel through the public network to send the message to another participant computer system.

### TECHNICAL FIELD

The present invention relates generally to methods and systems for performing data exchanges related to financial transactions. More particularly, the invention relates to a method for performing data and message exchanges over a public network and to a platform on which the data and message exchanges occur.

### BACKGROUND

Credit and debit transactions rely on message and data exchanges between participants (members, merchants, associations and cardholders). Traditionally, such transactions are performed over private networks and use proprietary protocols, each of which is used to reduce the likelihood that transactions will be compromised.

Currently, the exchange of information between a point of service terminal (POS) and an issuer of a credit or debit financial instrument (such as a credit card) occurs solely over such private networks. Even an e-commerce transaction receives cardholder information from the cardholder at a POS website and provides it to a member bank over an association-operated private network.

One problem with such private network systems is that each entity sponsoring credit or debit transactions requires a separate private network infrastructure. Moreover, each private network typically requires different protocols in order to perform transactions. As a result, users must subscribe to and use a plurality of such networks in order to satisfy their customer base.

In addition, the development of new products or services on such private networks is usually limited to the entity that operates the network. Accordingly, a bottleneck for the development of new products and services using the network can result. In contrast, new products and services could be developed more quickly if the members and/or merchants were able to develop services concurrently with the operating entity.

The emergence of the Internet as an alternative infrastructure for message and data exchange has resulted in the development and deployment of a plurality of new products and services in a variety of industries. For example, the evolution and growth of the Internet as a means for electronic transactions has continued to accelerate as improved standards emerge in the areas of technology and business.

Accordingly, what is needed is a public network platform that provides essential services related to financial transactions allowing participants to communicate and transact with one another securely and efficiently.

A need exists for a public network platform that reduces product and service costs for data exchanges related to financial transactions.

A further need exists for a public network platform for data exchanges related to financial transactions that increases the reliability of existing business services and streamlines maintenance, operations and user training.

A further need exists for a public network platform that reduces the development cost for developing innovative products and services related to financial transactions.

A still further need exists for a public network platform for performing data exchanges related to financial transactions that reduces the development lifecycle for new products and enhancements to current products.

The present embodiments are directed towards satisfying one or more of these problems.

### SUMMARY

Before the present methods and systems are described, it is to be understood that this invention is not limited to the particular methodologies and systems described, as these may vary. It is also to be understood that the terminology used in the description is for the purpose of describing the particular versions or embodiments only, and is not intended to limit the scope of the invention which will be limited only by the appended claims.

It must also be noted that as used herein and in the appended claims, the singular forms “a,” “an,” and “the” include plural references unless the context clearly dictates otherwise. Thus, for example, reference to a “message” is a reference to one or more messages and equivalents thereof known to those skilled in the art, and so forth. Unless defined otherwise, all technical and scientific terms used herein have the same meanings as commonly understood by one of ordinary skill in the art. Although any methods and systems similar or equivalent to those described herein can be used in the practice or testing of embodiments of the invention, the preferred methods and devices are now described. All publications mentioned herein are incorporated by reference. Nothing herein is to be construed as an admission that the invention is not entitled to antedate such disclosure by virtue of prior invention.

The present invention includes a system for transferring data related to financial transactions over a public network including a public network, and a plurality of participant computer systems. Each participant computer system is in communication with the public network. Each participant computer system includes one or more applications, and a gateway in communication with the public network. Each application is in communication with a gateway. Each application transmits and receives one or more messages to one or more participant computer systems to perform a function related to a financial transaction. The gateway provides a standard interface for sending and receiving data between applications over the public network. In an embodiment, the public network includes the Internet. In an embodiment, a message includes a header and a body. The header includes information used by the gateway to perform one or more functions. The body includes data transmitted by an application. The message body may include data in an Extensible Markup Language (XML) format.

For purposes of this application, the term “financial transaction” may include any exchange of value, which may be monetary, credits, loyalty points, or other units of measure, in a consumer, commercial, governmental or other transaction. In a preferred embodiment, a financial transaction may include any exchange of value related to a consumer transaction such as credit or debit transactions, exchanges of loyalty points, stored value transactions, cash advances, or any other transfers of value from a first account to a second account. In an alternate embodiment, financial transaction may include any exchange of value in a commercial, governmental or any other transaction such as the purchase, sale or exchange of investment instruments; commercial contracting transactions; commercial arbitrage; games of chance; or the delivery of government-sponsored benefits. It will be apparent to a person of ordinary skill that the present invention is equally effective for both card based transaction or non-card based transactions (i.e., where the needed account and/or other information can be accessed without the use of a card).

In an embodiment, a financial transaction may include the exchange of ancillary information related to the creation, maintenance, use, or termination of an account. For example, in such an embodiment, a financial transaction may include the exchange of control lists, policies, new and/or modified payment applications, and the like.

In an embodiment, the gateway performs one or more of transmitting a message, receiving a message, routing a message, resolving message header information, providing message reliability, performing message security, filtering a message, and performing message correlation. Transmitting a message may include receiving a message object from an application, determining one or more policies for the message based on any information resident in or provided to the gateway related to the message, resolving a transport address for a recipient of the message, applying one or more security features to the message, opening and securing a channel in the public network, and sending the message via the channel. The security features may include one or more of a digital signature and encryption. In an embodiment, receiving a message includes receiving a message from an application via the public network, retrieving one or more policies based on any information resident in or provided to the gateway related to the message, and delivering a message object to the receiving application. Receiving a message may further include using security policy information to verify a digital signature and/or using security policy information to decrypt the message. The policy may be express or implied by the other design features of the present invention.

In an embodiment, the gateway includes a gateway server in communication with the public network, a gateway client library in communication with the gateway server, and at least one application accessing the gateway client library via the gateway application programming interface. The gateway server queues incoming messages, opens channels, and maintains channels. The gateway client library interfaces with one or more protocols.

In an embodiment, a participant computer system further includes a directory accessible via the public network. The directory includes a storage device containing one or more entries. Each entry includes one or more identifiers and associated information, such as message routing data, metadata, and/or security policy information.

Channel security and message security may be performed using any known technique. In an embodiment, a public key infrastructure is used in combination with a certificate authority to implement channel and message security. The certificate authority is designed to be used in a manner such that it need not be involved, on a real time basis, in the verification of channels and messages. The certificate authority is used for mutual authentication, integrity checks, encryption and non-real time verification of channels and messages.

In an embodiment, a participant computer system further includes a platform service in communication with the public network. The platform service provides messaging services for messages routed through the platform service. The platform service may include a remote gateway service that enables an application that is remote from the participant computer system to access other gateways and applications. In an embodiment, the system may further include one or more consumer devices. Each consumer device may use the remote gateway service to access the public network. A consumer device may include one or more of a telephone, a cellular phone, a personal digital assistant, a handheld device, a set-top box and a personal computer. The platform service may include a broadcast message service that supports broadcast messaging and manages distribution lists for broadcast messages. The platform service may include a reliable messaging service that manages retransmission of messages, determines recipients and the like. The platform service may further include message logging for a mediated service or for auditing messages.

In an embodiment, a method for transmitting data related to financial transactions over a public network includes receiving a message object, including an identifier, such as a reference to a participant, a service, service data, a customer of the service, and/or a system component, generating a message from the message object, determining one or more policies for the message based on any information resident in or provided to the gateway related to the message, resolving a destination address for the message using an identifier, applying one or more security features to the message, opening and securing a channel in a public network to the destination address, and transmitting the message via the channel. The one or more policies may include one or more of a message security policy and a message routing policy. The public network may include one or more of a multi-hop topology, a hub and spoke topology, a peer-to-peer topology, and a fan-out topology. The identifier may include one or more of an organization identifier, an organization member identifier, a financial account identifier, a certificate authority identifier, a merchant identifier, a bank identifier, a service identifier, and a policy identifier. The one or more security features may include one or more of a digital signature and an encryption algorithm.

In an embodiment, a method of receiving data related to financial transactions over a public network includes receiving a message directed to a financial transaction application from a remote computer system, determining one or more policies applied to the message based on any information resident in or provided to the gateway related to the message, applying one or more security measures applied to the message, generating a message object from the message, and sending the message object to the application, wherein the message object includes an identifier. The one or more policies may include a message security policy. Applying one or more security measures may include verifying a digital signature and/or decrypting the message. The identifier may include one or more of an organization identifier, an organization member identifier, a financial account identifier, a certificate authority identifier, a merchant identifier, a bank identifier, a service identifier, and a policy identifier. In a preferred embodiment, the identifier may be a Uniform Resource Identifier (URI). In an alternate embodiment, the identifier may be an Extensible Resource Identifier (XRI).

In an embodiment, a method for transmitting financial transaction information using a remote gateway service includes receiving, from an application operated by a remote participant over a first network, financial transaction information by a remote gateway service, processing, by the remote gateway service, the financial transaction information, and transmitting, by the remote gateway service, the processed financial transaction information to a destination over a second network. In an embodiment, the method further includes receiving, by the remote gateway service from the second network, a response to the processed financial transaction information, processing, by the remote gateway service, the response, and transmitting, by the remote gateway service to the application operated by the remote participant over the first network, the processed response.

### BRIEF DESCRIPTION OF THE DRAWINGS

The accompanying drawings, which are incorporated in and form a part of the specification, illustrate various embodiments and, together with the description, serve to explain the principles of the various embodiments.

FIG. 1 depicts an exemplary system model for a platform for performing data exchanges related to financial transactions according to an embodiment.

FIG. 2 depicts an exemplary architecture for a message bus according to an embodiment.

FIG. 3 depicts an exemplary architecture for a message bus according to an embodiment.

FIG. 4 depicts an exemplary gateway architecture according to an embodiment.

FIG. 5 depicts an exemplary directory implementation within a transaction platform according to an embodiment.

FIG. 6 depicts exemplary certificate authorities for messaging related to a financial transaction according to an embodiment.

FIG. 7 depicts an exemplary platform service within a transaction platform according to an embodiment.

FIG. 8 depicts an exemplary remote gateway service according to an embodiment.

FIG. 9 depicts an exemplary message flow using a remote gateway service according to an embodiment.

### DETAILED DESCRIPTION

The present invention relates to methods and systems for performing message exchanges related to financial transactions. The invention particularly relates to a method for performing such message exchanges over a public network and to a platform on which the message exchanges occur.

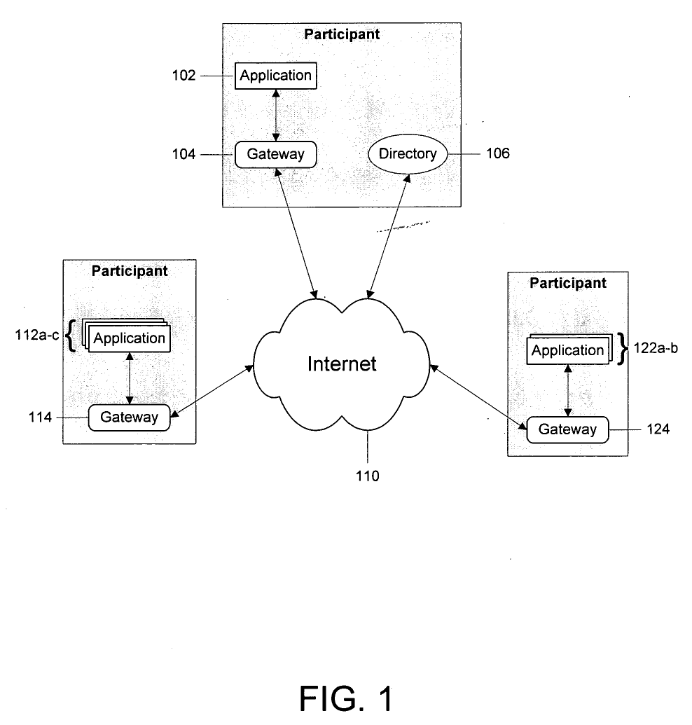

FIG. 1 depicts an exemplary system model for a platform for performing data exchanges related to financial transactions according to an embodiment. As shown in FIG. 1, the system model may be based on a message bus architecture for use by one or more of the following participants: an organization sponsoring financial transactions, such as credit and debit transactions, members of the organization, merchants, governments and other relevant entities. The architecture may include applications (such as 102, 112a-c and 122a-b), which exchange messages over the network platform 110 via gateways (such as 104, 114 and 124), one or more directories 106 that support addressing and message routing, and the protocols and interfaces that define communication between these components.

An application may use distributed processing across a plurality of participant systems attached to a network platform 110. For the purposes of this disclosure, an application includes the set of interactions between one or more computer systems and the processing steps on the one or more computer systems that realize a function.

A gateway may provide a standard interface for sending and receiving messages in the platform 110. A gateway may further handle message routing, reliability, security and correlation.

A directory 106 may contain one or more identifiers or names to permit the sending, receiving and unique identification of messages in the platform 110. A directory may further include message routing data, metadata and/or security policy information. Although only one directory is shown in FIG. 1, a plurality of directories may be attached to a platform 110.

Platform protocols may define the interface for communication on the platform 110. For example, protocols may define the process by which messages are sent between gateways, the interaction between gateways and directories and/or applications, the syntax and semantics of messages, the format by which platform resources are identified and the resolution of the resource identifier format. The protocols, when taken together with the functionality of the directories and gateways, may provide applications with an environment that supports an entity's messaging needs.

A message is a discrete unit of data transmitted across the platform 110. Application data is converted into one or more messages when it is transmitted. A message may include two parts: a header and a body. The header includes information used by the platform 110 in delivering the message. The body includes the data being transmitted. In an embodiment, the message body is formatted as Extensible Markup Language (XML) content. In an embodiment, each message transmitted on the platform 110 conforms to the SOAP specification.

Platform messaging types may include peer-to-peer, hub and spoke, fan-out and mediated messaging. Peer-to-peer messaging may include a direct communication between a sender and a receiver. For example, peer-to-peer messaging occurs when one server communicates directly with another server. Hub and spoke messaging requires all communication to be routed through a central hub. Mediated messaging is a generalization of hub and spoke messaging in which at least one intermediary is involved in delivering a message from a sender to a receiver.

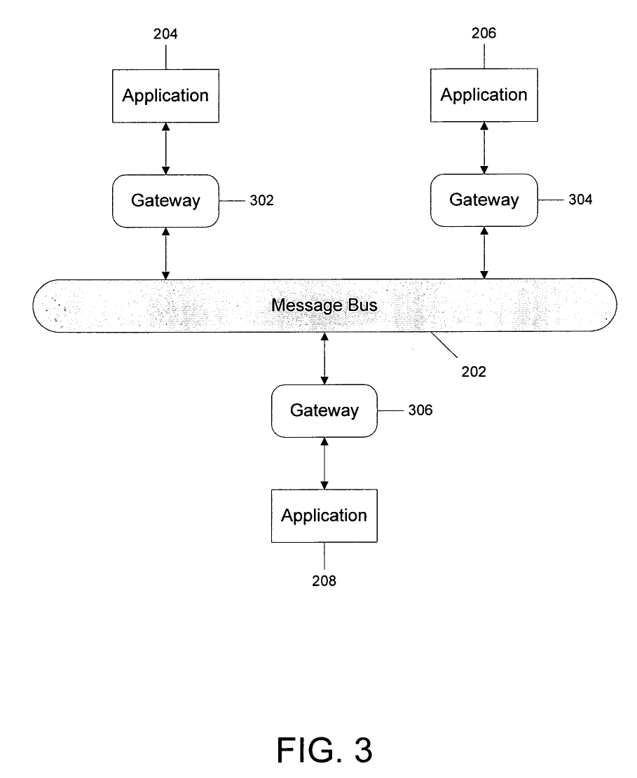

The underlying infrastructure for the platform may use asynchronous messaging. However, applications may simulate synchronous messaging through the use of gateway application programming interfaces (APIs), which are described in reference to FIG. 3 below, and message identifiers. Gateways may assign a message identifier to each message to permit gateways and applications to correlate related messages. For example, in a request-response message pattern, the response message may contain its message identifier and also the message identifier of the request message. Thus, synchronous messaging may be achieved by i) using a blocking call when a message is sent and ii) having the gateway correlate message identifiers.

The platform 110 may support a plurality of message patterns either in the API directly or through message correlation. The message pattern types may include, without limitation, fire-and-forget, request-response, remote procedure call (RPC), broadcast notification, conversation, request with multiple responses, and/or broadcast with multiple responses.

The fire-and-forget message pattern occurs when a sender sends a message to a single recipient. An application-level response is not required for a fire-and-forget message pattern.

The request-response message pattern occurs when a sender sends a message to a single recipient that requires an application-level response from the receiver. The recipient then sends a response to the sender.

The RPC message pattern is a form of the request-response message pattern in which a sender invokes a service by passing parameters that are serialized into a message for transmission to the recipient. The recipient then sends a response to the sender.

The broadcast notification message pattern occurs when a sender sends a message to a plurality of recipients. An application-level response is not required.

The conversation message pattern involves two participants engaged in a transaction utilizing a plurality of message exchanges.

The request with multiple responses message pattern occurs when a sender sends a message to a single recipient. The recipient returns multiple response messages to the original sender.

Finally, the broadcast with multiple responses message pattern occurs when a sender sends a message to a set of recipients. One or more of the recipients may return one or more responses to the original sender.

The above-described message patterns are merely illustrative of the types of message patterns that may be implemented in the platform. Applications may implement other message patterns using one or more gateway APIs and information such as message identifiers.

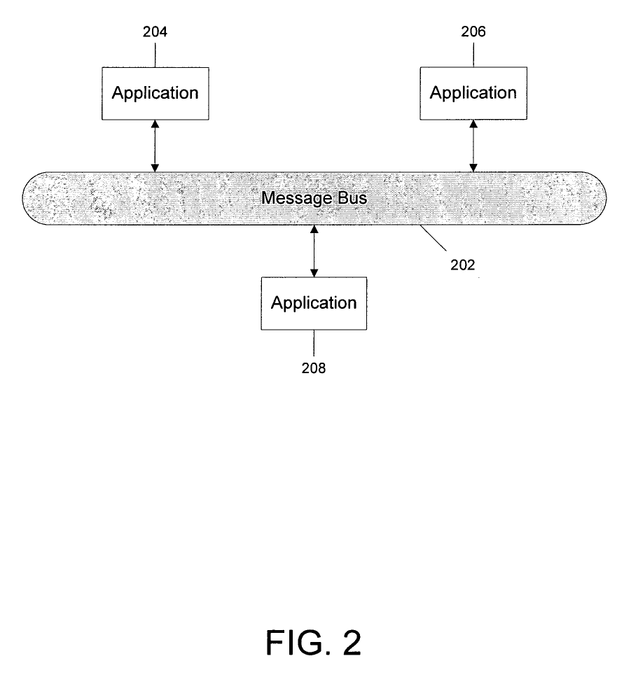

FIG. 2 depicts an exemplary architecture for a message bus between applications according to an embodiment. The message bus 202 may permit different systems or applications to communicate over a shared infrastructure with a common interface. The platform may include a message bus architecture that enables applications 204-208 to communicate with one another in a standard and secure fashion. As shown in FIG. 2, the message bus architecture may resemble a computer hardware bus architecture. Other implementations are possible and are encompassed within the scope of this disclosure.

Message busses are commonly used for application and system integration within an enterprise. The bus may be implemented using products such as TIBCO's Rendezvous™ and/or IBM's MQSeries™ products.

With the advent of the Internet, the message bus architecture has frequently been extended to inter-enterprise integration. However, the architecture typically requires that the effected enterprises adopt a single proprietary product, adopt a single service provider, and/or create standardized interface specifications that support a variety of competing vendor products and/or service providers. In an embodiment, specifications defining a global trusted message bus are implemented using competing vendor products and region-specific services to support a variety of product and service needs.

One or more standards, such as the Hypertext Transfer Protocol (HTTP), SOAP, Transport Layer Security (TLS), Web Services Security (WS-Security), the Uniform Resource Identifier (URI), the Extensible Resource Identifier (XRI), the Security Assertion Markup Language (SAML), and/or similar standards, may define protocols used by the platform.

HTTP is a transport protocol used by the World Wide Web that defines how messages are formatted and transmitted and what actions Web servers and browsers should take in response to various commands. HTTP may be used to transmit, for example, SOAP messages within the platform.

SOAP is a lightweight XML protocol for the exchange of information in decentralized, distributed environments. SOAP may be used to define the format of messages and the messaging model used by the platform according to an embodiment.

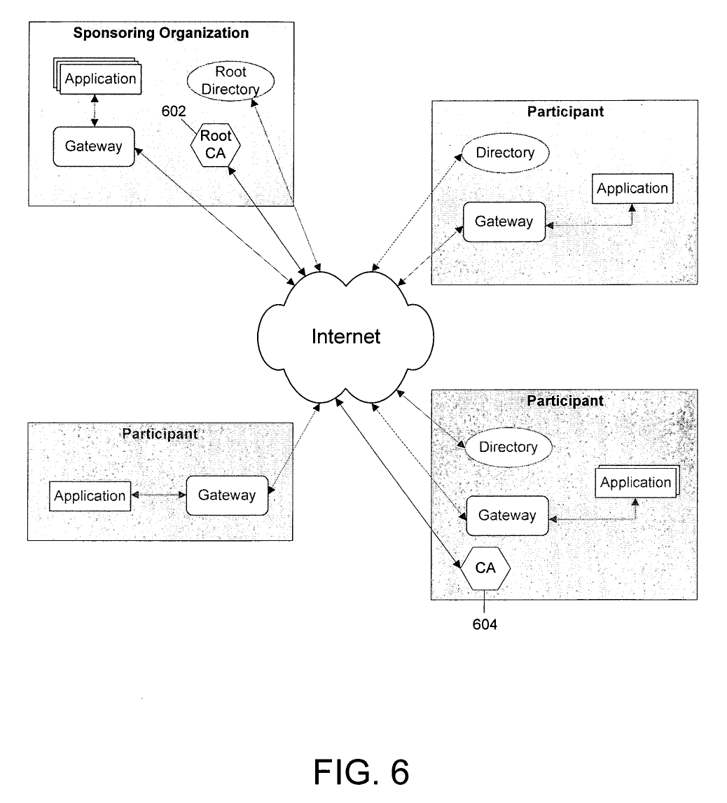

TLS is a protocol used to secure and authenticate communications across public platforms by using data encryption and digital signatures. TLS may be used to secure connections between message senders and message receivers within the platform. TLS is devised to ensure that no third party eavesdrops or tampers with any message when a server and client communicate. TLS may be composed of two layers: the TLS Record Protocol and the TLS Handshake Protocol. The TLS Record Protocol may provide connection security using an encryption method. The TLS Record Protocol may also be used without encryption. The TLS Handshake Protocol may allow the server and the client to authenticate each other and to negotiate an encryption algorithm and cryptographic keys before data is exchanged. In an embodiment, a certificate authority, such as 602 or 604 as described below in reference to FIG. 6, may provide one or more keys to one or more gateways for use in performing the authentication and/or negotiation steps.

WS-Security defines enhancements to SOAP messaging that provide message integrity and confidentiality. The specified mechanisms may be used to accommodate a plurality of security models and cryptographic technologies. WS-Security may define message-level security within the platform by defining message signatures and message encryption.

URIs are compact strings of characters that identify abstract or physical resources on a network: documents, images, downloadable files, services, electronic mailboxes, and other resources. URIs provide a common format for accessing resources using a variety of naming schemes and access methods such as HTTP, FTP, and Internet mail.

URLs (Uniform Resource Locators) are a subset of URIs that identify resources via a representation of their primary access mechanism (e.g., their network location), rather than identifying the resource by name or by some other attribute(s) of that resource.

The XRI specification defines an identifier that builds on the URI specification. The XRI specification adds an additional structural layer to generic URIs and defines a resolution scheme to make XRIs usable in a variety of contexts. XRIs may be used to identify resources (such as participants sending and receiving messages) within the platform.

SAML is an XML-based framework for exchanging security information. SAML may be used to define security assertions for message-level security, authentication and authorization. Similar frameworks may also be used within the scope of this invention.

FIG. 3 depicts an exemplary architecture for a message bus between applications including gateways according to an embodiment. A gateway, such as each of 302-306, is a component of the message bus architecture in the platform that may provide the interface for sending and receiving messages and handling message routing, reliability, security and correlation. The gateway may function in a manner similar to a web server in that each permits applications and content to be divorced from the details of connection management, session management, etc. A gateway may allow a messaging application to be isolated from the details of message routing, security, channel setup and management, etc. Systems supporting the functionality shown in FIG. 3 may be referred to as SOAP nodes.

A gateway may securely send and receive messages using one or more of the standards described above in reference to FIG. 2. In addition, gateway functionality may include message routing, identifier resolution and caching, message correlation, secure messaging and/or message filtering. Message filtering may permit a gateway to reject or register a fault for particular messages based on policies that consider, for example, the sender, the recipient, the message type and/or other data that the gateway can access.

To send a message, a gateway may perform, for example, the following operations: receiving a message object from an application, retrieving a policy for the message (including security policies and routing policies), consulting an appropriate directory to resolve the transport address for the recipient, applying the appropriate security features (signatures, encryption, etc.), opening or reusing a channel (such as an HTTPS connection to the recipient), securing a channel, and sending the message via the channel. Message objects may include methods to sign messages, verify signatures on messages, encrypt application data and/or decrypt application data.

To receive a message, a gateway may perform, for example, the following operations: receiving a message from another application, retrieving one or more policies for the message (this may be performed to determine any security policies and/or the receiving application for the message), using security policy information to verify signatures and decrypt the message, if applicable, and/or delivering a message object to the receiving application.

Applications may use a gateway API to exchange messages with a gateway. In an embodiment, the API may be object-oriented and define messages and channels.

A channel may connect a sender to one or more recipients. The channel may include a logical path through which messages pass. Channel objects may include methods to send and receive messages.

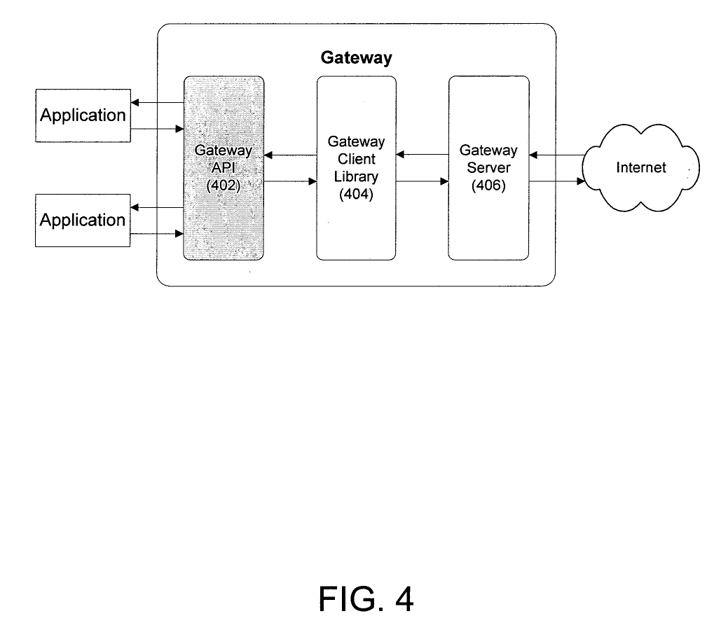

FIG. 4 depicts an exemplary gateway architecture according to an embodiment. In an embodiment, a gateway includes a gateway API 402, a gateway client library 404 and a gateway server 406. The gateway server 406 may queue messages, open and maintain connections, and perform other similar operations. The gateway client library 404 may connect the gateway API 402 to the gateway server 406 and perform one or more protocols. The gateway API 402 may provide an interface between one or more applications and the other components of the gateway. Alternate gateway implementations may distribute the functions of a gateway differently. For example, in alternate embodiments either the gateway client library 404 or the gateway server 406 may encrypt a message requiring message-level encryption. Additionally, although FIG. 4 shows the gateway API 402, the gateway client library 404, and the gateway server 406 as physically separate components, a person of ordinary skill in the art will readily appreciate that the components may be logically or physically distinct.

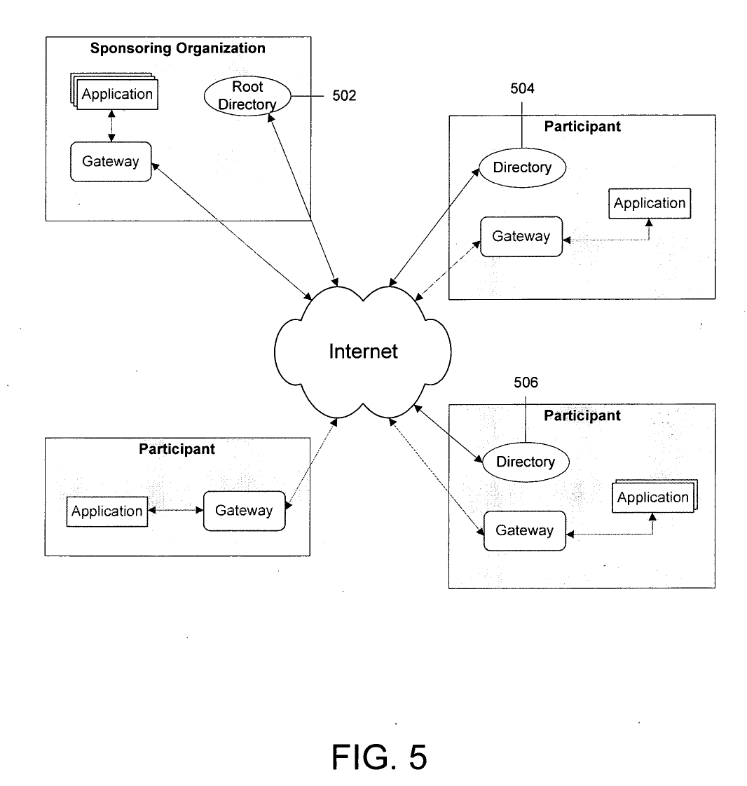

FIG. 5 depicts an exemplary directory implementation within a transaction platform according to an embodiment. A directory, such as each of 502-506, manages information regarding resources within the platform. This information may be used to name, describe, locate and/or access system resources. The named or identified resources may include participants, gateways, directories, applications and the like. By providing consistent references for such resources, the directory structure and the stored identifiers may maintain the integrity of the platform.

In an embodiment, identifiers and their associated data may be stored in directories for the purpose of facilitating application-to-application messaging. The platform may be used to flexibly define identifier namespaces.

One or more identifier schemes may be used with the directory structure. An identifier scheme is a specification of the syntax and semantics of identifiers. For example, the HTTP Uniform Resource Locator (URL) specification defines an identifier scheme for identifying web pages and other web resources.

In an embodiment, an XRI identifier scheme may be used. XRIs may be location-independent since the context of an XRI is decoupled from the network location of any data or services associated with it. Accordingly, accessing a resource associated with an XRI may not be limited to a particular platform location or protocol.

A namespace is a grouping of identifiers in which all of the identifiers are unique with respect to each other. In an embodiment, identifiers may be hierarchical in nature.

Delegation of namespaces (i.e., entrusting control of a portion of a namespace to an organization) is a well-established and critical practice. For example, primary account numbers (PANs) for credit/debit cards are exemplary identifiers that are both hierarchical and delegated. A PAN may be, for example, a 16-digit to 19-digit identifier including an issuer institution identifier (six digits) and a cardholder identifier (ten to thirteen digits). Issuer institution identifiers may be assigned to organizations. The first digit in an issuer institution identifier may identify an organization. The subsequent five digits may be used to identify a member of the organization. A member may then assign the cardholder identifier as a delegate of the organization.

In an embodiment, an XRI namespace may be developed to correspond to a PAN. For example, an organization namespace may occupy the first portion of the XRI (“xri:@organization”). To identify specific members, the organization could then extend the namespace to include a string that uniquely identifies a member (“xri:@organization/somemember”). The remainder of the namespace may then be delegated to the member. In other words, the member may further extend the namespace to identify any resource that requires identification, such as a cardholder account (“xri:@organization/somemember/someaccount”).

In an embodiment, syntactic restraints are imposed upon the delegated portion of the namespace to ensure consistency across the platform. For example, the “someaccount” portion of the namespace may be required to match some regular expression or format, such as using a certain number of characters, using digits only, etc. Other methods of describing namespace identifiers are envisioned within the scope of the present invention.

Directories 502-506 used within the platform may support addressing and routing of messages by storing identifiers and associated data. For example, an application may send a message using a PAN-like member identifier. The gateway may use an XRI to query a directory, which returns a transport address (a HTTPS URL) for that member. In addition, data such as security policy information may be supported in the directories.

In an embodiment, only gateways directly interact with directories. The gateway may perform identifier resolution for the application. In an embodiment, a resolution protocol may be implemented using a resolver library and a directory. The resolver library may be a part of the gateway that interacts with directories. Resolution may be achieved using one or more of the following operations: i) passing a designator for a recipient from the gateway to the resolver library after receiving a message to send; ii) examining the designator, by the resolver library, to determine which directory (or identifier authority) contains the information associated with the designator; iii) sending, by the resolver library, a secure request for that data to the directory; iv) opening, by the gateway, a secure connection to the directory; v) performing, at the directory, a look up of the descriptor document (e.g., an XML document that contains routing and other information) associated with the designator in question; vi) transmitting the descriptor document from the directory to the gateway (possibly via the resolver library); and vii) processing, by the gateway, the information in the descriptor document to transmit the message.

Directories may be managed or deployed alongside applications and gateways. However, this is not required for directories to function within the present invention. Directories may be populated and maintained through implementation-specific means and may be implemented on top of an existing data store or completely native implementations. Moreover, directories may be linked together through delegated identifier namespaces allowing for local management and control of identifiers by each participant. This, in turn, allows for local provisioning and data management behind the directory and does not require cross-directory management tools or specifications.

FIG. 6 depicts exemplary certificate authorities for data exchanges related to a financial transaction according to an embodiment. A variety of security features may be built into the platform to ensure that the platform can send and receive messages in a trusted fashion. To achieve this goal, the platform may leverage a transport-level security mechanism (such as TLS), a message-level security mechanism (such as WS-Security), and a public key infrastructure (PKI) including certificates.

At the transport layer, the platform may use mutually authenticated TLS connections to verify the authenticity of the gateways attempting to communicate with one another. The TLS connections may further maintain data integrity and ensure the authenticity of the messages transmitted over the connection.

At the message layer, the platform protocol may use security specifications such as WS-Security, XML encryption and XML digital signatures or similar protocols. Gateways may be responsible for applying encryption and decryption to message bodies to implement message-level security. Additional security features may be applied to the body of messages for more robust application-to-application security. For example, if end-to-end encryption that extends beyond a platform is required, an application may perform application-specific encryption to message bodies before transmitting messages to a gateway. A similar operation may be performed for digital signatures.

In an embodiment, anonymous participation in the platform is not permitted. Participants may identify themselves using certificates in both transport-level and message-level security. Each participant may present a valid certificate chain that is rooted in an organization certificate authority 602. All gateways, applications and directories using the platform may have certificates issued by (or on behalf of) the sponsoring organization establishing that the gateway, application or directory is authorized to use the platform. Although the sponsoring organization may host the root certificate authority 602, other participants may host a certificate authority 604 as well.

In an embodiment, a gateway can attempt to resend a message a predetermined number of times. A message may be resent if an acknowledgment message is not received within a predetermined timeout period. If the message has not been delivered within the predetermined number of attempts, a fault message may be returned to the sending application.

The platform may also support failover routing. Failover routing permits a primary gateway to specify one or more backup gateways. If a message cannot be delivered to the primary gateway, the platform may attempt to send the message to each of the backup gateways in a specified order.

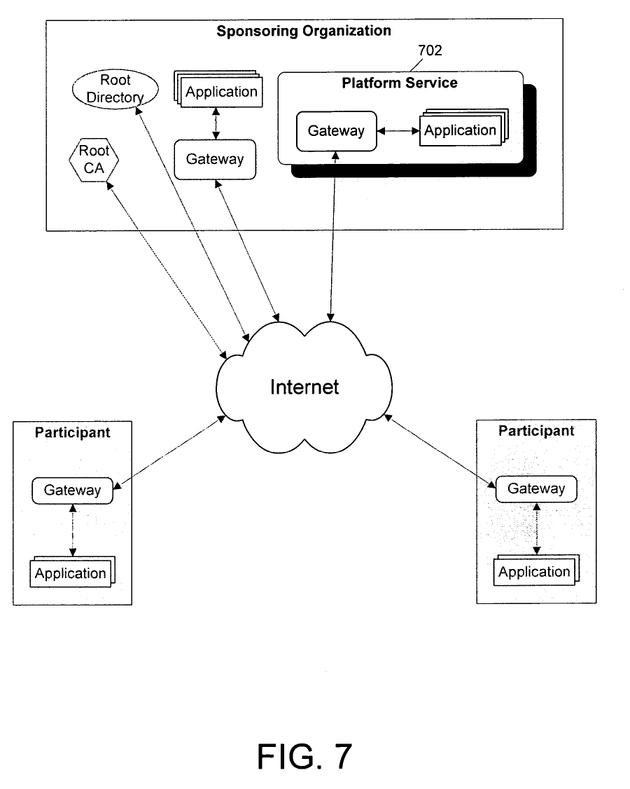

FIG. 7 depicts an exemplary platform service within a transaction platform according to an embodiment. New features, enhancements and extensions of existing services may be added to the platform by creating service offerings called platform services, such as 702. A platform service 702 may include a special-purpose application hosted only by the sponsoring organization or a trusted third party. A platform service 702 may provide additional services or functionality to messages that are routed through the service. For example, a platform service 702 may implement a guaranteed message delivery service that both offers geographic failover and provides high guarantees of message delivery. In another example, a broadcast platform service may support the broadcast message pattern and the provisioning and management of the distribution lists to which messages are broadcast.

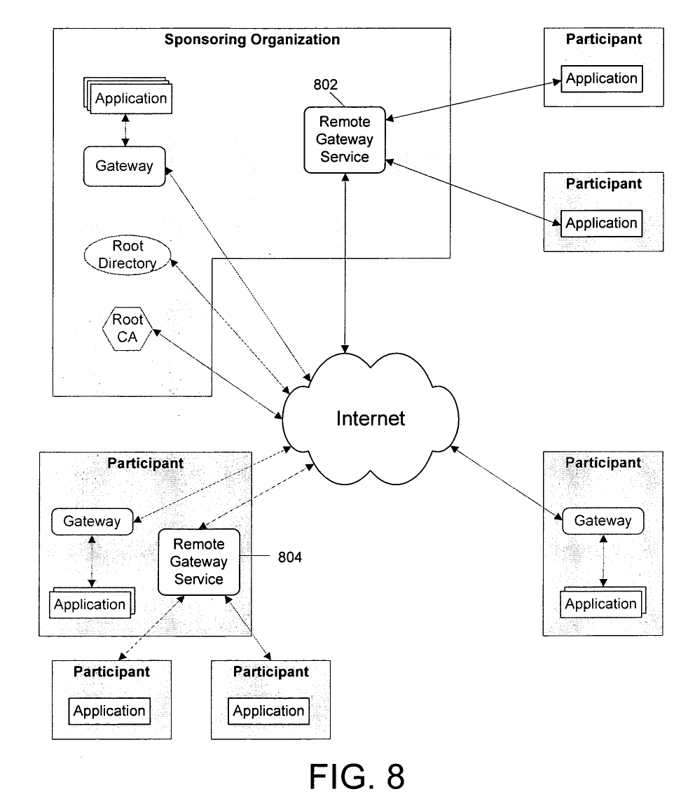

An exemplary platform service is depicted in FIG. 8. A remote gateway service 802, 804 may provide enterprise networks with the ability to use the platform without hosting a gateway. The remote gateway service may be used, for example, by participants that merely wish to provide applications to the platform. Remote participants may access the platform through the sponsoring organization's gateway 802 or through any other participant's gateway 804.

In an embodiment, one or more consumer devices may be used to send messages to and receive messages from the public network via a remote gateway service. Such consumer devices may use a remote gateway service because the consumer devices are unlikely to be either always connected to the network or trusted to be a full participant on the network. A consumer device may include, for example, a telephone, a cellular phone, a personal digital assistant, a handheld device, a set-top box, a personal computer, or any other electronic communications device used by a consumer.

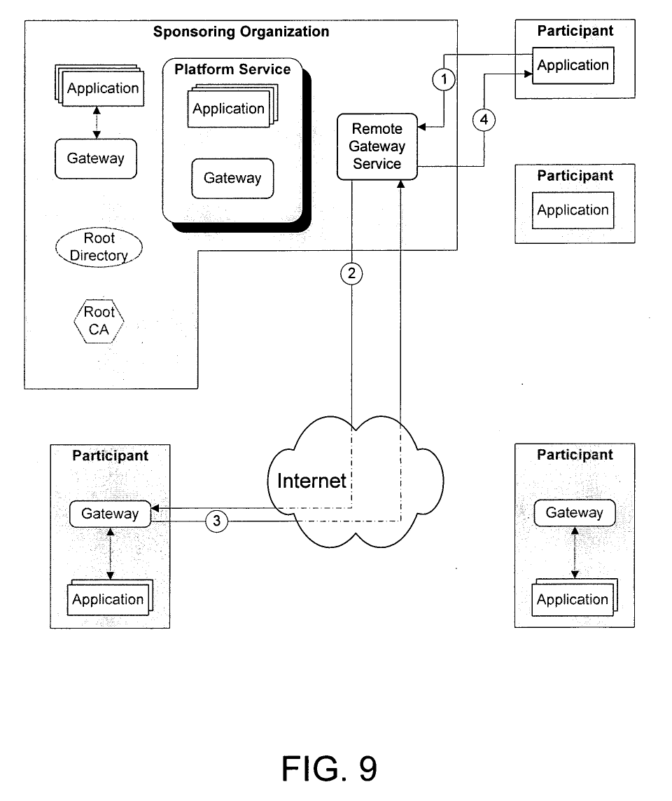

FIG. 9 depicts an exemplary message flow using a remote gateway service according to an embodiment. In an embodiment, an application operated by a remote participant 902 may send a message to a remote gateway service 904. The remote gateway service 904 may reside at the sponsoring organization or another participant. The remote gateway service 904 may process the message and transmit the message through a channel to the destination gateway 906 and, ultimately, the destination application. Responses from the destination application may be received by the remote gateway service 904 and forwarded to the remote participant application.

It is to be understood that the invention is not limited in its application to the details of construction and to the arrangements of the components set forth in this description or illustrated in the drawings. The disclosed method and system are capable of other embodiments and of being practiced and carried out in various ways. Hence, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the disclosed embodiments.

We claim:

1. A system for exchanging data related to financial transactions utilizing a public network, the system comprising:
a plurality of participant computer systems, each in communication with the public network, wherein each participant computer system comprises:
one or more applications for performing functions related to a financial transaction, and
a gateway in communication with both the public network and the one or more applications, wherein the gateway provides an interface for sending and receiving data between applications over the public network; and
one or more private directories in communication with the public network, wherein the directories are effective for identifying a trusted messaging path between the participant computer systems.

2. The method of claim 1 wherein the one or more private directories are accessible only to the plurality of participant computer systems.

3. The method of claim 1 wherein the one or more private directories identify each of the trusted resources available to the plurality of computer systems.

4. The method of claim 1 wherein the trusted messaging path comprises authorized participant computer systems identified in the one or more private directories.

5. The method of claim 1 wherein the financial transaction comprises one or more of the following:
a credit card transaction;
a debit card transaction;
a calling card transaction;
a stored value transaction;
a loyalty card transaction; and
a coupon transaction.

6. The method of claim 1, wherein the financial transaction comprises an exchange of investment instruments.

7. The method of claim 1, wherein the financial transaction comprises the delivery of government benefits.

8. The method of claim 1 wherein the financial transaction comprises any exchange of value.

9. The system of claim 1 wherein the public network comprises the Internet.

10. The system of claim 1 wherein the data is exchanged using a message format comprising a header and a body, wherein the header includes information used by the gateway to perform one or more functions, wherein the body includes data transmitted by an application.

11. The system of claim 10 wherein the gateway performs one or more of the following:
transmitting a message;
receiving a message;
routing a message;
resolving message header information;
providing message reliability;
performing message security;
filtering a message; and
performing message correlation.

12. The system of claim 11 wherein transmitting a message comprises:
receiving a message from an application;
determining one or more policies for the message based on a message type for the message;
resolving a transport address for a recipient of the message;
applying one or more security features to the message;
opening and securing a channel in the public network; and
sending the message via the channel.

13. The system of claim 12 wherein the security features comprise one or more of a digital signature and encryption.

14. The system of claim 11 wherein receiving a message comprises:
receiving a message from the public network;
retrieving one or more policies based on a message type for the message;
applying each policy to the message; and
delivering the message to a receiving application.

15. The system of claim 14 wherein applying comprises using security policy information to verify a digital signature.

16. The system of claim 14 wherein applying comprises using security policy information to decrypt the message.

17. The system of claim 1 wherein the gateway comprises:
a gateway server in communication with the public network, wherein the gateway server queues incoming messages, opens channels, and maintains channels;
a gateway client library in communication with the gateway server, wherein the gateway client library interfaces with one or more protocols; and
a gateway application programming interface in communication with the gateway client library and at least one application.

18. The system of claim 1 wherein a participant computer system further comprises:
a directory accessible via the public network, wherein the directory comprises a storage medium containing one or more entries, wherein each entry comprises one or more identifiers.

19. The system of claim 18 wherein the identifiers comprise one or more of message routing data, metadata, and security policy information.

20. The system of claim 1 wherein a participant computer system further comprises:
a certificate authority in communication with the public network, wherein the certificate authority provides one or more keys to the gateway for use in performing one or more of mutual authentication of channels, mutual authentication of messages, integrity checks for channels, integrity checks for messages, channel encryption and message encryption.

21. The system of claim 1 wherein a participant computer system further comprises:
a platform service in communication with the public network, wherein the platform service provides messaging services for messages routed through the platform service.

22. The system of claim 21 wherein the platform service comprises a remote gateway service, wherein the remote gateway service provides access to the public network for an application that is remote from the participant computer system.

23. The system of claim 22, further comprising one or more consumer devices, wherein each consumer device uses the remote gateway service to access the public network.

24. The system of claim 23 wherein a consumer device comprises one or more of a telephone, a cellular phone, a personal digital assistant, a handheld device, a set-top box and a personal computer.

25. The system of claim 21 wherein the platform service comprises a broadcast message service, wherein the broadcast message service supports broadcast messaging and manages distribution lists for broadcast messages.

26. A method for transmitting data related to financial transactions over a public network, the method comprising:
receiving a message object from a first trusted participant, wherein the message object includes an identifier;
generating a message from the message object;
determining one or more policies for the message;
resolving a destination address for the message using the identifier;
applying one or more security features to the message;
opening and securing a channel in a public network to the destination address wherein the destination address identifies a second trusted participant; and
transmitting the message to the second trusted participant via the channel.

27. The method of claim 26 wherein the one or more policies include one or more of a message security policy and a message routing policy.

28. The method of claim 26 wherein the one or more policies comprise one or more of a multi-hop routing policy, a hub and spoke routing policy, a peer-to-peer routing policy, and a fan-out routing policy.

29. The method of claim 26 wherein the identifier comprises one or more of an organization identifier, an organization member identifier, a financial account identifier, a certificate authority identifier, a merchant identifier, a bank identifier, a service identifier, a service identifier, and a policy identifier.

30. The method of claim 26 wherein the one or more security features include one or more of a digital signature and an encryption algorithm.

31. The method of claim 26 wherein the first trusted participant and the second trusted participant are identified in one or more private directories accessible to the first trusted participant and the second trusted participant.

32. The method of claim 31 wherein the first trusted participant and the second trusted participant possess the necessary security authorization to exchange messages.

33. A method of receiving data related to financial transactions over a public network, the method comprising:
receiving a message from a remote trusted computer system, wherein the message is directed to a financial transaction application;
determining one or more policies applied to the message;
applying one or more security measures applied to the message;
generating a message object from the message; and
sending the message object to the application, wherein the message object includes an identifier.

34. The method of claim 33 wherein the one or more policies includes a message security policy.

35. The method of claim 33 wherein applying one or more security measures comprises verifying a digital signature.

36. The method of claim 33 wherein applying one or more security measures comprises decrypting the message.

37. The method of claim 33 wherein the identifier comprises one or more of an organization identifier, an organization member identifier, a financial account identifier, a certificate authority identifier, a merchant identifier, a bank identifier, a service identifier, a service identifier, and a policy identifier.

38. A method for transmitting financial transaction information using a remote gateway service, the method comprising:
receiving, from an application operated by a remote participant over a first network, financial transaction information by a remote gateway service;
processing, by the remote gateway service, the financial transaction information; and
transmitting, by the remote gateway service, the processed financial transaction information to a destination over a second network.

39. The method of claim 38, further comprising:
receiving, by the remote gateway service from the second network, a response to the processed financial transaction information;
processing, by the remote gateway service, the response; and
transmitting, by the remote gateway service to the application operated by the remote participant over the first network, the processed response.
